(19) United States
(12) Patent Application Publication
(10) Pub. No.: US 2007/0058616 A1
(43) Pub. Date: Mar. 15, 2007

(54) Method, system and terminal for implementing information transfer services

(76) Inventor: Dawei Li, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/512,573

(22) Filed: Aug. 30, 2006

(30) Foreign Application Priority Data
Sep. 1, 2005 (CN) 2005 10098209.7

(51) Int. Cl. H04L 12/66

(52) U.S. Cl. 370/352; 370/395.1; 709/204

(57) ABSTRACT

The present invention discloses a method for implementing information transfer services, including: A. generating, by a sending terminal, an address of the information to be sent, and sending, by the sending terminal, the address via a Wireless Application Protocol (WAP) short message to a receiving device of the information; and B. obtaining, by the receiving device, the information from the sending terminal according to the received address. This invention also discloses a system for implementing information transfer services and a terminal. This invention makes it possible to realize simple and low-cost information transfer services and ensures the success rate of information transfer.

### FIELD OF THE INVENTION

The present invention relates to the field of information transfer technique in a wireless communication system, and more particularly, to a system, method and terminal for implementing information transfer services.

### BACKGROUND OF THE INVENTION

Multimedia Message Service (MMS) is a further evolution of Short Message Service (SMS) and Enhanced Message Service (EMS), which provides an integrated end-to-end solution for personal multimedia mobile communication services. In terms of communication contents, a multimedia message may include pictures, voices, video, data, and etc.

The architecture of a system for implementing an MMS, email service and Enhanced MMS (EMMS) is shown in FIG. 1, in which the most important entities for implementing MMS include MMS User Agents (UA) and MMS Centers (MMSC). An MMS UA is an application module at a terminal. The module may be used for browsing, editing, and processing MMS messages in addition to transferring and receiving MMS messages as an agent of a user. An MMSC has functions of an MMS relay and an MMS Server for implementing protocol transformation, content adaptation, storage, and scheduling of MMS messages, and carrying out the delivering operation of MMS messages between different multimedia devices. Besides the MMS UA and MMSC, the system may further include an MMS database, an email server, an external enhanced application server, e.g., Service Provider/Content Provider (SP/CP), Redirector, etc. The MMS database may be for storing user information, customized information, interface information, etc; the email server may be for providing email services for terminals; the SP/CP may be for providing EMMS; and the Redirector may be for redirecting MSS messages between the MSS UA and MMSC such that the terminal may be able to allocate a submitted message to the terminal's home MMSC without being configured with a fixed MMSC address.

A flowchart for implementing an MMS service in the related art is shown in FIG. 2. Supposing that the sending terminal is terminal 1 and the receiving terminal is terminal 3, the flowchart includes the following specific steps:

Step 201: after constructing an MMS message, terminal 1 sends the constructed MMS message to its home MMSC via an M-Send.req message.

Step 202: after the MMSC to which terminal 1 belongs receives the MMS message, it returns an M-Send.conf message to terminal 1 so as to confirm that this MMS message has been received;

Step 203: the MMSC to which terminal 1 belongs transfers the MMS message to an MMSC of the receiving party, i.e., the MMSC to which terminal 3 belongs, via an MM4-Forward.req message.

Step 204: after the MMSC to which terminal 3 belongs receives this MMS message, it returns an MM4-Forward.res message to the MMSC to which terminal 1 belongs so as to confirm that the message has been received;

Step 205: the MMSC to which terminal 3 belongs sends to terminal 3 an M-Notification.ind message in a form of a short message;

Step 206: after terminal 3 receives the M-Notification.ind message, it returns an M-NotifyResp.ind message to the MMSC which terminal 3 belongs to;

Step 207: a while later, terminal 3 confirms that the MMS message has been received, and then sends a Get.req message to the MMSC which terminal 3 belongs to;

Step 208: after receiving the Get.req message, the MMSC to which terminal 3 belongs delivers the corresponding message to terminal 3 via an M-Retrieve.conf message;

Step 209: after downloading the MMS message successfully, terminal 3 sends its home MMSC an M-Acknowledge.ind message so as to inform the MMSC that the download of this MMS message is done;

Step 210: after the MMSC to which terminal 3 belongs receives the M-Acknowledge.ind message sent by terminal 3, the MMSC sends an MM4-DeliverReport.req message to the MMSC terminal 1 belongs to, informing the MMSC that terminal 3 has received the MMS message;

Step 211: the MMSC to which terminal 1 belongs sends an MM4-DeliverReport.res message to the MMSC which terminal 3 belongs to, confirming that it has received a Delivery Report and notifying that it has learned that terminal 3 has received the MMS message;

Step 212: the MMSC to which terminal 1 belongs sends an M-Delivery.ind message to terminal 1, notifying terminal 1 that terminal 3 has accomplished receiving the MMS message.

Like the transferring method of the MMS, when a terminal sends an email to an email server or an EMMS message to an SP/CP, it is necessary in the related art to send the email or EMMS message to an MMSC first, and then the MMSC sends the email or EMMS message to the corresponding email server or SP/CP.

As seen from the foregoing schemes, in the related art process of a terminal implementing the information transfer services such as the MMS, email service, and EMMS, the information has to be forwarded by an MMSC. So each MMSC has to transfer such a large amount of information that each MMSC is required to have more powerful processing abilities, which increases the system costs for implementing MMS services. If the network needs to accommodate large numbers of subscribers, it is necessary to set up more MMSCs to satisfy the demands, which leads to a big waste of devices;

### SUMMARY

The present invention discloses a method for implementing information transfer services, including:

A. generating, by a sending terminal, an address of the information to be sent, and sending, by the sending terminal, the address via a Wireless Application Protocol (WAP) short message to a receiving device of the information; and

B. obtaining, by the receiving device, the information from the sending terminal according to the received address.

The present invention further discloses a system for implementing information transfer services, including:

a sending terminal, configured to generate an address of the information to be sent, and send this address to a receiving device via a WAP short message;

a WAP network gateway, configured to transfer information between the sending terminal and the receiving device, and

a receiving device, configured to, receive the WAP short message from the sending terminal, and obtain the information via the WAP network gateway from the sending terminal according to the address contained in the WAP short message.

The present invention further discloses a terminal, including:

an Point-to-Point MMS UA module, configured to, browse, edit, and process information, generate an address of the information to be sent, output this address through a WAP PUSH short message to a WAP interface module; and

a WAP interface module, configured to establish a connection between Point-to-Point MMS UA module and a WAP network gateway, and send the WAP PUSH short message to a receiving device via the WAP network gateway.

### BRIEF DESCRIPTION OF THE DRAWINGS

The accompanying drawings, which are incorporated in and constitute a part of this specification, illustrate the invention and together with the description, and serve to explain the principles of the invention.

In the drawings, FIG. 1 is an architecture map of a system for implementing an MMS service, email service, and EMMS in the related art;

FIG. 2 is a flowchart of implementing the MMS service in the related art;

FIG. 3 is a general flowchart of a method for implementing information transfer services according to a preferred embodiment of the present invention;

FIG. 4 is an architecture map for implementing MMS services according to a preferred embodiment of the invention;

FIG. 5 is a flowchart of implementing MMS services according to an preferred embodiment of the invention;

FIG. 6 is a flowchart of implementing email services according to an preferred embodiment of the invention; and

FIG. 7 is a flowchart of implementing EMMS according to a preferred embodiment of the invention.

### DETAILED DESCRIPTION OF PREFERRED EMBODIMENTS

To make the objective, technique schemes and advantages of this invention clearer, this invention is further described in detail hereinafter with reference to the accompanying drawings.

An embodiment of the invention is that, a sending terminal generates an address for information which is to be sent and sends the address to a receiving device of the information via a Wireless Application Protocol PUSH (WAP PUSH) short message, and then the receiving device obtains the information from the sending terminal according to the received address. In this way, an information transfer service is realized.

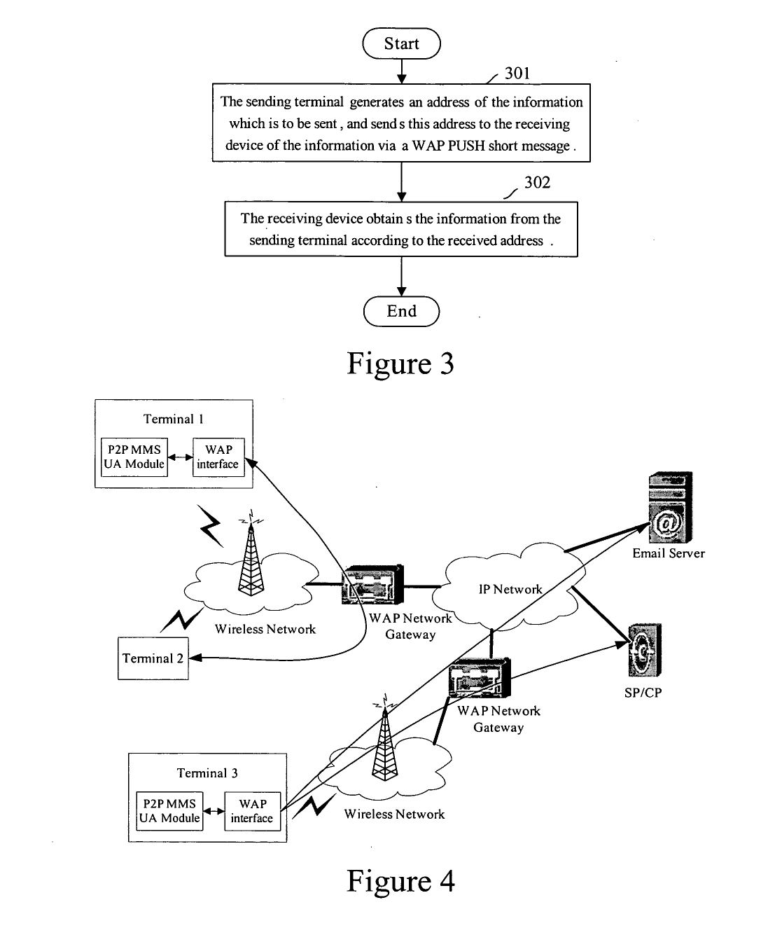

The general flowchart of a method for implementing information transfer services according to a preferred embodiment of the present invention is shown in FIG. 3. The method includes the following steps:

Step 301: a sending terminal generates an address for information which is to be sent, and sends this address to a receiving device of the information via a WAP PUSH short message.

Step 302: the receiving device obtains the information from the sending terminal according to the received address.

Detailed descriptions of this invention are provided by embodiments as follows.

As shown in FIG. 4, architecture of a system for implementing an MMS service, mail service, and EMMS in an embodiment of this invention includes: terminal 1, terminal 2, terminal 3, wireless networks, WAP network gateways, an IP network, a mail server, and an SP/CP.

Terminal 1 contains a point-to-point (P2P) MMS UA module and a WAP interface module. The P2P MMS UA module can be for providing functions of browsing, editing, and processing MMS for users, sending an M-Notification.ind message to terminal 2, and sending an MMS message to terminal 2 after receiving a Get.req message sent by terminal 2. The method of the P2P MMS UA module providing functions of browsing, editing, and processing MMS for users may be the same as the one in the related art. The WAP interface module may be for establishing a connection with a WAP network gateway so that the P2P MMS UA module may exchange information with the WAP network gateway via the established connection.

Terminal 2 may be either a terminal containing a P2P MMS UA module or the same terminal as the one in the related art, and it may be for receiving an MMS message from terminal 1 via the WAP network gateway after receiving an M-Notification.ind message from terminal 1.

The wireless network, WAP network gateway, and IP network are for providing network services for terminal 1 and/or terminal 2, and for transferring messages between terminal 1 and terminal 2.

The email server and SP/CP are for getting the corresponding information according to the address contained in the WAP PUSH short message sent by a terminal.

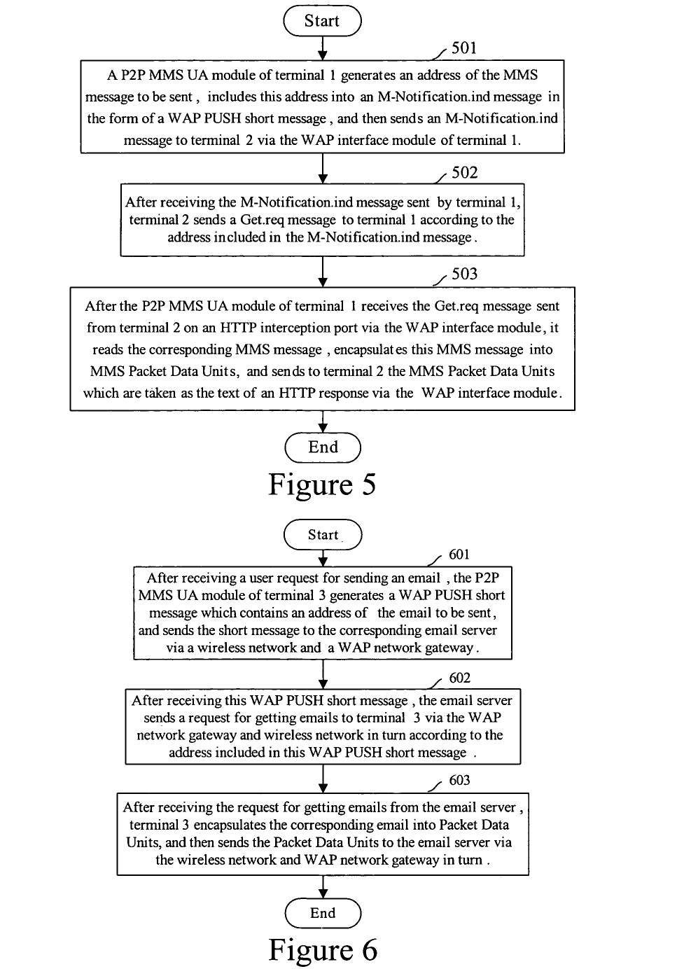

In the foregoing system, the procedure of terminal 1 sending an MMS message to terminal 2 is shown in FIG. 5. As the messages exchanged between terminal 1 and terminal 2 are first sent to the WAP network gateway by the sending terminal via the wireless network, then sent to the receiving terminal by the WAP network gateway via the wireless network gateway. Moreover, the realization of transferring information between terminals via the wireless network and WAP network gateway may be the same as that in the related art, so for brevity, the message exchanging between terminals via the wireless network and WAP network gateway in the following steps are directly described by the interaction between the terminals while the process of the wireless network and WAP network gateway is omitted. The procedure includes the following steps:

Step 501: after receiving a P2P MMS request from a user, the P2P MMS UA module of terminal 1 generates an address for an MMS message which is to be sent, includes this address in an M-Notification.ind message in a format of a WAP PUSH short message, and then sends this message to terminal 2 via a WAP interface module.

In this step, generating an address for the MMS message which is to be sent refers to generating a link address of an M-Notification.ind message in a form of WAP PUSH, wherein the link address may be expressed as a Content Location, etc. In addition, the link address may be generated automatically according to the IP address allocated by the network side which may be obtained by the WAP interface module and the identifier of the MMS to be sent by a user which is configured on a terminal, e.g., HTTP://10.11.22.33:8080/12345, wherein HTTP://10.11.22.33 is the IP address of the terminal sending the MMS, 8080 refers to an interception port, and 12345 is the identifier of the MMS message configured on terminal 1.

In addition, in this step, if there are abundant IP resources in the network where terminal 1 is located, it is possible to make the terminal on line permanently. For instance, in an IPV6 network, as terminal 1 may own an IP address without application, its Hypertext Transfer Protocol (HTTP) service interception may start directly, and thus this step may be performed directly. However, if it is needed to allocate resources dynamically in the network where terminal 1 is located, e.g., in a GPRS network, before generating an M-Notification.ind message, terminal 1 needs to send a request for activating a GPRS context to the network side via a WAP interface first; and after the network side receives the request for activating a GPRS context, it opens a data network channel for terminal 1, activates a GPRS context, allocates an IP address for terminal 1, then sends the IP address to the WAP interface module in terminal 1, and after allocating an interception port, the WAP interface module in terminal 1 starts an HTTP interception on this IP address.

Step 502: after receiving the M-Notification.ind message sent by terminal 1, terminal 2 sends a Get.req message to terminal 1 according to the link address included in the M-Notification.ind message, such as a Content Location.

Step 503: after the P2P MMS UA module of terminal 1 receives the Get.req message from terminal 2 on the HTTP interception port via the WAP interface module, it reads the corresponding MMS message, encapsulates this MMS message into MMS Packet Data Units, and sends an M-Retrieve.conf message as the text of an HTTP response to terminal 2 via the WAP interface module.

In step 503, if the network where terminal 1 is located needs to allocate IP address resources dynamically, after finishing sending the MMS message, the WAP interface module in terminal 1 needs to disconnect the HTTP data link, deactivate the data link, and release the network resources such as the IP address etc. Since there is a confirmation mechanism for the reception of data packages in the Transportation Control Protocol (TCP) of the HTTP, after the WAP interface module makes sure that terminal 2 has finished receiving data packages based on the confirmation mechanism, it is confirmed that terminal 2 has finished sending the MMS message.

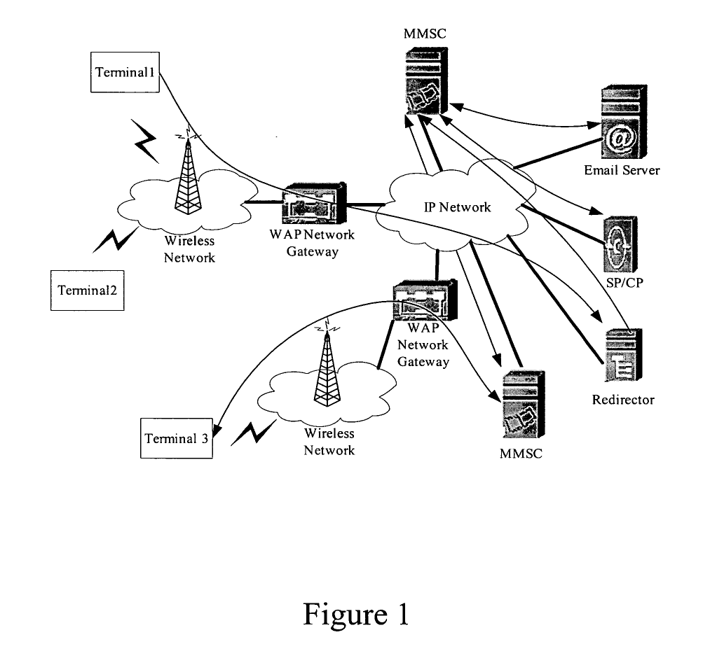

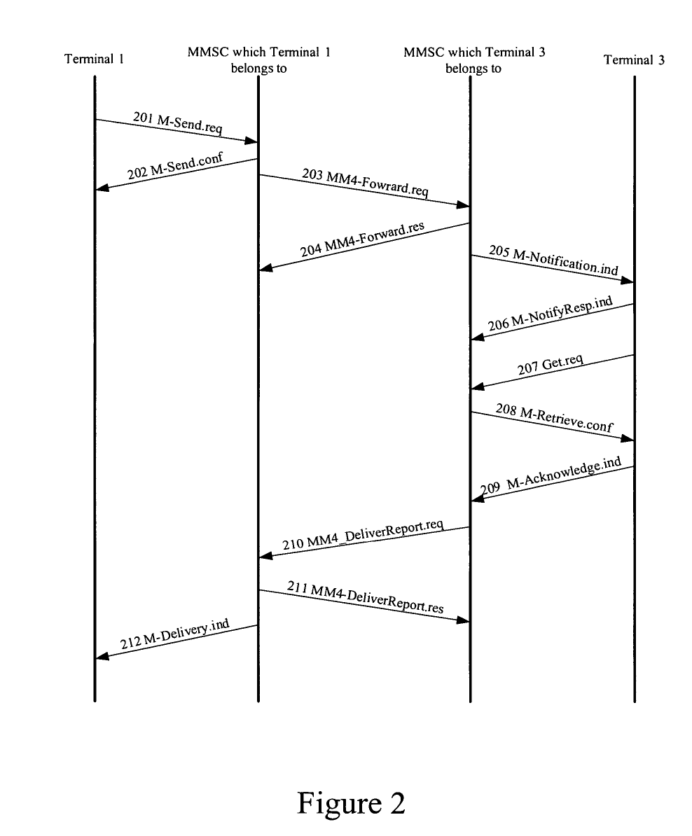

In this embodiment, information server addresses may be set in a P2P MMS UA module as well, thus terminal 1 may be able to receive MMS messages from a related art terminal, of which the specific implementing procedure is the same as the flowchart shown in FIG. 2, so it is not necessary here to give a further description about this procedure.

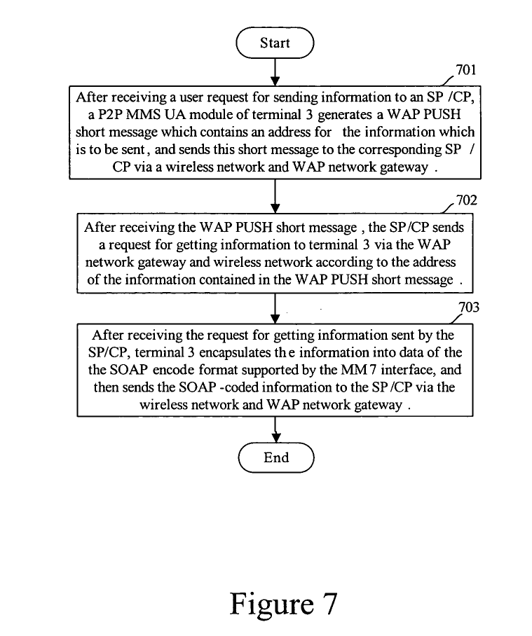

In this embodiment, the terminal with a P2P MMS UA module may also implement sending emails to an email server or EMMS messages to an SP/CP. The procedures of terminal 3 in FIG. 4 sending an email to an email server and sending an EMMS message to an SP/CP are illustrated in FIG. 6 and FIG. 7, respectively. FIG. 6 is a flow chart of implementing email services in an embodiment of this invention. As shown in FIG. 6, the procedure of terminal 3 sending an email to an email server includes:

Step 601: after receiving a user request for sending an email, the P2P MMS UA module of terminal 3 generates a WAP PUSH short message which contains an address of an email to be sent, and sends the short message to the corresponding email server via a wireless network and WAP network gateway. Similar to Step 501, the address of the email mentioned in this step includes: an IP address and interception port of terminal 3, and an identifier of this email configured on terminal 3.

Step 602: after receiving this WAP PUSH short message, the email server sends a request for getting an email to terminal 3 via the WAP network gateway and wireless network in turn according to the address included in this WAP PUSH short message.

Step 603: after receiving the request for getting an email from the email server, terminal 3 encapsulates the corresponding email into Packet Data Units, and then sends the Packet Data Units to the email server via the wireless network and WAP network gateway in turn.

FIG. 7 is a flow chart of implementing EMMS in an embodiment of the invention. As shown in FIG. 7, the procedure of terminal 3 sending an EMMS message to an SP/CP includes:

Step 701: after receiving a user request for sending information to an SP/CP, the P2P MMS UA module of terminal 3 generates a WAP PUSH short message which contains an address of information to be sent, and sends this short message to the corresponding SP/CP via a wireless network and WAP network gateway. Similar to Step 501 and Step 601, the address of the information mentioned above contains: an IP address and interception port of terminal 3, and an identifier of the information to be sent configured on terminal 3.

Step 702: after receiving the WAP PUSH short message, the SP/CP sends to terminal 3 a request for getting information via the WAP network gateway and wireless network according to the address of the information contained in the WAP PUSH short message.

Step 703: after receiving the request for getting information sent by the SP/CP, terminal 3 carries out Simple Object Access Protocol (SOAP) encoding for the information to be sent by a user to the SP/CP in a format of an MM7-Submit.req message, i.e., encapsulates this information into data of a SOAP encode format supported by the MM7 interface, and then sends the SOAP encode information to the corresponding SP/CP via the wireless network and WAP network gateway.

The foregoing is a description of embodiments of this invention. Proper modifications may be conducted on the method during specific implementations of this invention so as to accommodate the needs of specific situations. Therefore, it is easy to understand that the embodiments based upon the invention are for demonstrations rather than for limiting the protection scope of the invention.

1. A method for implementing information transfer services, comprising:
A. generating, by a sending terminal, an address of the information to be sent, and sending, by the sending terminal, the address via a Wireless Application Protocol (WAP) short message to a receiving device of the information; and
B. obtaining, by the receiving device, the information from the sending terminal according to the received address.

2. The method according to claim 1, wherein, the information is a Multimedia (MM) message; and the receiving device is a terminal.

3. The method according to claim 1, wherein, the information is an email; and the receiving device is an email server.

4. The method according to claim 2, wherein, the format of the information which the receiving device obtains from the sending terminal in Step B is Package Data Units (PDU).

5. The method according to claim 3, wherein, the format of the information which the receiving device obtains from the sending terminal in Step B is PDU.

6. The method according to claim 1, wherein, the information is an Enhanced Multimedia Message Service (EMMS) message; and the receiving device is an external enhanced application server.

7. The method according to claim 6, wherein, the format of the information which the receiving device obtains from the sending terminal in Step B is a Simple Object Access Protocol (SOAP) encode format.

8. The method according to claim 1, wherein, the address comprises: the IP address of the sending terminal, an identifier of the information configured at the sending terminal, and an interception port for intercepting the IP address of the sending terminal.

9. A system for implementing information transfer services, comprising:
a sending terminal, configured to generate an address of the information to be sent, and send this address to a receiving device via a WAP short message;
a WAP network gateway, configured to transfer information between the sending terminal and the receiving device, and
the receiving device, configured to, receive the WAP short message from the sending terminal, and obtain the information via the WAP network gateway from the sending terminal according to the address contained in the WAP short message.

10. (canceled)

11. A terminal, comprising:
a Point-to-Point MMS UA module, configured to, browse, edit, and process information, generate an address of the information to be sent, output this address through a WAP PUSH short message to a WAP interface module; and
the WAP interface module, configured to establish a connection between Point-to-Point MMS UA module and a WAP network gateway, and send the WAP PUSH short message to a receiving device via the WAP network gateway.

12. A method for implementing information transfer services, applied to a communication system including a sending unit, a Wireless Application Protocol (WAP) network gateway, and a receiving unit, comprising:
generating, by the sending unit, an address of the information;
sending, by the sending unit, the address to the receiving unit via the WAP network gateway; and
upon receiving the address, obtaining, by the receiving unit, the information via the WAP network gateway from the sending unit according to the address.

13. The method according to claim 12, wherein, sending, by the sending unit, the address to the receiving unit via the WAP network gateway, comprises:
generating, by the sending unit, a WAP PUSH message which contains the address of the information; and
pushing, by the sending unit, the WAP PUSH message via the WAP network gateway to the receiving unit.

14. The method according to claim 12, wherein, obtaining, by the receiving unit, the information via the WAP network gateway from the sending unit according to the address, comprises:
sending, by the receiving unit, a request for getting the information to the sending unit via the WAP network gateway based on the received address; and
upon receiving the request for getting information, sending, by the sending unit, the information to the receiving unit via the WAP network gateway.

15. The method according to claim 14, wherein, the address of the information comprises: an IP address of the sending unit and an identifier of the information configured on the sending unit;
sending, by the receiving unit, a request for getting the information to the sending unit based on the received address, comprises: sending, by the receiving unit, the request for getting the information according to the IP address of the sending unit included in the received address of the information, and carrying, by the receiving unit, an identifier of the information configured on the sending unit in this request for getting information, and
sending, by the sending unit, the information to the receiving unit, comprises: getting the information according to the identifier of the information carried in the request for getting the information and sending the information.

16. The method according to claim 14, before, sending, by the sending unit, the information to the receiving unit, further comprising: carrying out a format transformation for the information to be sent.

17. The method according to claim 16, wherein if the information to be sent is an MMS message, the receiving unit is a terminal; and if the information to be sent is an email, the receiving unit is an email server; and
the format transformation for the information comprises encapsulating the information into Packet Data Units (PDU).

18. The method according to claim 16, wherein if the information to be sent is an EMMS message, the receiving unit is an external enhanced application server; and
the format transformation for the information comprises encapsulating the information into data of a SOAP encode format supported by the MM7 interface.

19. The method according to claim 15, wherein the address of the information further comprises: an interception port for intercepting the IP address of the sending unit.

20. A method for implementing information transfer services, applied to a communication system including a first terminal, a second terminal, a WAP network gateway, an email server, and an external enhanced application server, comprising:
generating, by the first terminal, an address of the information to be sent;
sending, by the first terminal, the address to the second terminal, the email server, or the external enhanced application server via the WAP network gateway; and
upon receiving the address, obtaining, by the second terminal, the email server, or the external enhanced application server, the information via the WAP network gateway from the sending unit according to the address.

21. The method according to claim 20, wherein, sending, by the first terminal, the address to the second terminal, the email server, or the external enhanced application server via the WAP network gateway, comprises:
generating, by the first terminal, a WAP PUSH message which contains the address; and
pushing, by the first terminal, the WAP PUSH message via the WAP network gateway to the second terminal, the email server, or the external enhanced application server.

22. The method according to claim 20, wherein, wherein, upon receiving the address, obtaining, by one of the second terminal, the email server, and the external enhanced application server, the information via the WAP network gateway from the sending unit according to the address, comprises:
upon receiving the address, sending, by one of the second terminal, the email server, and the external enhanced application server, a request for getting the information via the WAP network gateway to the first terminal based on the received address; and
upon receiving the request for getting information, sending, by the first terminal, the information via the WAP network gateway to one of the second terminal, the email server, and the external enhanced application server, which has sent the request for getting information.

23. A system for implementing information transfer services, comprising:
a sending unit, configured to generate an address of information, and send this address to a receiving unit via a WAP network gateway;
the WAP network gateway, configured to receive the address from the sending unit, send this address to the receiving unit, and
the receiving unit, configured to, via the WAP network gateway, receive the address of the information sent by the sending unit and obtain the information from the sending unit according to this address.

24. The system according to claim 23, wherein,
the sending unit is further configured to include the generated address of the information in a WAP PUSH message and send this WAP PUSH message to the WAP network gateway;
the WAP network gateway is further configured to receive the WAP PUSH message containing the address from the sending unit and push this WAP PUSH message to the receiving unit; and
the receiving unit is further configured to receive the WAP PUSH message containing the address of the information from the WAP network gateway and analyze the WAP PUSH message to get the address of the information.

25. The system according to claim 23, wherein,
the receiving unit is further configured to, upon receiving the address of the information, sending a request for getting the information to the sending unit via the WAP network gateway;
the sending unit is further configured to, upon receiving the request for getting information, sending the information to the receiving unit via the WAP network gateway.

26. A system for implementing information transfer services, comprising:
a first terminal, configured to generate an address of information, and send this address to a second terminal, an email server, or an external enhanced application server, via a WAP network gateway;
the WAP network gateway, configured to receive the address from the first terminal, send this address to one of the second terminal, the email server, and the external enhanced application server, and
each of the second terminal, the email server, and the external enhanced application server, configured to, via the WAP network gateway, receive the address of the information sent by the first terminal and obtain the information from the first terminal according to this address.

27. The system according to claim 26, wherein,
the first terminal is further configured to generate a WAP PUSH message which contains the address of information, push the WAP PUSH message via the WAP network gateway to one of the second terminal, the email server, and the external enhanced application server.

28. The system according to claim 26, wherein,
each of the second terminal, the email server, and the external enhanced application server is further configured to, upon receiving the address, send a request for getting the information via the WAP network gateway to the first terminal based on the received address; and
the first terminal is further configured to, upon receiving the request for getting the information, send the information via the WAP network gateway to one of the second terminal, the email server, and the external enhanced application server, which has sent the request for getting the information.

29. A terminal, comprising:
an MMS UA, configured to generate an address of information, include this address in a WAP PUSH message, output the WAP PUSH message to a WAP interface, and send the information to the WAP interface; and the WAP interface, configured to receive the WAP PUSH message from the MMS UA, send the WAP PUSH message to a WAP network gateway, and transfer the information from the MMS UA to the WAP network gateway.
